(19) United States
(12) Patent Application Publication
(10) Pub. No.: US 2015/0242314 A1
(43) Pub. Date: Aug. 27, 2015

(54) MOTION PROCESSING MEMORY ARCHITECTURE

(71) Applicant: George Hsu, Boca Raton, FL (US)

(72) Inventor: George Hsu, Boca Raton, FL (US)

(73) Assignee: PNI Sensor Corporation, Santa Rosa, CA (US)

(21) Appl. No.: 14/622,845

(22) Filed: Feb. 14, 2015

Related U.S. Application Data
(60) Provisional application No. 61/943,409, filed on Feb. 23, 2014.

(51) Int. Cl. G06F 12/06; G01C 19/00; G01P 15/14

(52) U.S. Cl. CPC G06F 12/0638; G01P 15/14; G01C 19/00; G06F 2212/205

(57) ABSTRACT

Methods, apparatuses and systems sensed signal processing are disclosed. One apparatus includes a plurality of sensors, code space ROM (read only memory), code space RAM, and data space RAM (random access memory), wherein the data space RAM comprises a reconfigurable pointer table for maintaining a pointer address to instructions of one or more sensor data processing functions within the code space ROM and code space RAM. The apparatus further includes a processor, where the processor operative to receive sensor data from the plurality of sensors, retrieve the one or more sensor data processing functions from the code space ROM and code space RAM as pointed to by the reconfigurable pointer table, and perform processing of the sensor data using the retrieved one or more sensor data processing functions.

### RELATED APPLICATIONS

This patent application claim benefit of U.S. Provisional Patent Application Ser. No. 61/943,409, filed Feb. 23, 2014, which is herein incorporated by reference.

### FIELD OF THE EMBODIMENTS

The described embodiments relate generally to an electronic device. More particularly, the described embodiments relate to memory architecture for sensed motion processing.

### BACKGROUND

There are many specialized embedded, deeply embedded microcontroller and dedicated DSP sensing and motion sensing applications that require small size, low cost and low power consumption. Typically, these applications operate on real world inputs that are variable in nature, especially sensors that measure motion such as gyroscopes, accelerometers and magnetometers. The combination of these sensors for fused sensor applications require complex algorithmic processing to generate outputs in the form of rotational angles, such as Quaternions, that a host can then use to run applications. Often, these algorithms can be improved over time in order to accommodate more features or increased reliability. Also, given that a large variety of applications may develop over time, the algorithms may need to be adjusted on an application by application basis. Thus some fundamental aspects of the code embedded into the processors may need to change on a regular basis.

Masked Read Only Memory (ROM) is low cost, very small in footprint on an integrated circuit and is exceptionally low power. These advantages come at the cost of inflexibility. The masked ROM is programmed in the last metal layer to be applied during the fabrication process of microcontroller wafers, so once completed the code is unchangeable. There are other non-volatile memory technologies, such as One Time Programmable (OTP) and Electrically Erasable Programmable Read Only Memory (EEPROM), but OTP's cannot be programmed more than once, and there needs to be specialized high voltage generating circuitry in order to do so. EEPROM is writable and erasable over many cycles, but its structure is very large, so is much more expensive to implement per bit than other memory technologies. Thus it is never used to program more than a few bytes worth of data, most typically coefficients or security codes and serial numbers and is rapidly being replaced by other technologies, such as Flash memory.

Flash memory is the reprogrammable memory of choice but has limitations in the number of read/write cycles that can be performed before bit failure—somewhere between 10K and 100K times. The process to fabricate Flash memory also requires many more masking steps during fabrication than standard CMOS logic, thus significantly increases cost. A further disadvantage to Flash memory is that additional logic and associated algorithms are needed to manage the lifecycle of its memory bits as they start to fail during use.

Random Access Memory is overwhelmingly used for operating variable data storage and manipulation. It cannot retain its memory contents between power cycles of a device, has a large footprint in comparison to non-volatile memory and requires much more power to operate per bit than does non-volatile memory. It is a poor choice for code memory in that the operating code would have to be downloaded booted up every time the device is re-powered up. The chip would be very large and the power consumption would be high if the entire code memory consisted of RAM. Clearly, what is needed for low cost, complex and flexible computational devices is a different approach.

It is desirable to have a method, system and apparatus for low cost and low power memory architecture for sensed motion processing.

### SUMMARY

One embodiment includes a motion sensing processing apparatus. The apparatus includes a plurality of sensors, data space RAM (random access memory), code space ROM (read only memory) and code space RAM and a reconfigurable pointer table for maintaining a pointer address to instructions of one or more sensor data processing functions contained within the code space ROM and code space RAM. The processor is operative to retrieve the one or more sensor data processing functions from the code space ROM and code space RAM as pointed to by the reconfigurable pointer table and perform processing of the sensor data using the retrieved one or more sensor data processing functions.

Another embodiment includes a method of motion sensing processing. The method includes receiving sensor data from a plurality of sensors, retrieving one or more sensor data processing functions from code space ROM and code space RAM as pointed to by a reconfigurable pointer table stored in data space RAM and processing the sensor data using the retrieved one or more sensor data processing functions.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a block diagram of a sensor processing memory architecture, according to an embodiment.

FIG. 2 shows motion sensors and an adaptive filter for providing sensor inputs to the sensor processing architecture, according to an embodiment.

FIG. 3 shows a block diagram of ROM wherein fixed subroutines are stored for use by a main program stored in RAM, according to an embodiment.

FIG. 4 shows motion sensors and an adaptive filter for providing sensor inputs to the sensor processing architecture, according to another embodiment.

FIG. 5 shows motion sensors and an adaptive filter for providing sensor inputs to the sensor processing architecture, according to another embodiment.

FIG. 6 is a flow chart that includes steps of a method of a sensor processing memory architecture, according to an embodiment.

FIG. 7 shows a block diagram of a mobile device that includes at least some embodiments of the sensor processing memory architecture, according to an embodiment.

### DETAILED DESCRIPTION

The described embodiments provide way of combining ROM (and ROM can be extended to mean a fixed logical implementation of a computational building block such as dedicated gate-level logic that is a fixed state-machine) and RAM for use in program space, such that the vast majority of the code resides in ROM (or logical gates) with a small amount of program RAM that contains a small program wrapper (a MAIN loop, for instance), changeable components (such as device drivers) and the ability of the code in RAM to substitute any functional block that may already exist in ROM for an improved functional copy at a subroutine level. This is accomplished by a combination of compiler, linker and address pointer table that exists in RAM (and is reconfigurable) that can call code elements that either exists in ROM or RAM.

For at least some embodiments a majority of the motion processing code is included in subroutine or functional block form within the ROM where the memory can be up to three times more dense and power efficient than RAM memory, yet retain the flexibility of how the wrapper calls the various programmatic components of what resides in ROM in order to create powerful and field reprogrammable algorithms at a fraction of the cost and power consumption of alternative approaches. Thus a small object code file of wrapper program can be uploaded to RAM of at least some of the described embodiments via a serial protocol, such as SPI (Serial Peripheral Interface) or I2C (Inter IC), in order for the described embodiments to run. There is no limitation on the number of write/erase cycles for RAM, and so the re-configurability of the device has no set limitation. Logic can also be implemented so that such a device can receive its RAM operating code via an upload upon power up from an external standalone memory device such as a dedicated EEPROM as well.

In a specific embodiment, a sensor fusion (or motion) coprocessor used in conjunction with an application processor in a mobile communication device is a good area for at least some of the described embodiments to be applied. Typically, application processors on mobile devices are geared towards graphics rendering, running applications and managing communications infrastructures such as voice, data and WiFi. These processors are exceptionally powerful but also power hungry, so using them to perform sensor fusion (especially where the fusion has to be always-on in some sort of background operating capacity) would quickly drain the system's battery. Thus a smaller coprocessor device makes sense for such a use case. However, sensor fusion requires powerful floating point math, vector and matrix operations, and transcendental functions such as trigonometric operations. These necessary functions for sensor fusion can reside either in gate level state machines or ROM code space to serve as invariant building blocks as such operations tend not to change. Even higher-level subroutines composed of these functions can also be constructed in such a way that changes are unlikely to be necessary over time as the algorithms evolve. These higher-level functions include digital filtering, feature extraction and probability estimation. It is the order of calling these functions and what their inputs are designated to be that can change, so therefore the code for such requirements would go into the RAM code space in the form of a unique program wrapper. Furthermore, the design of the architecture, allows any of the functions within ROM code space to be freely substituted and replaced by alternative functions running out of RAM code space as well. This feature enables updating functionality over time as well as bug fixes should they be necessary. In effect, when implemented properly, versions of the fusion code could be masked, deployed to market, and when improvements need to be made or bugs are found, new RAM patch code can easily generated and loaded into the device's RAM code space, operated, tested. Once such changes are stable the latest code running in RAM code space can be frozen and then committed to the next generation of the masked ROM whenever appropriate. This creates a platform that never needs to be fundamentally redesigned except on one metal layer. It can be seen that such a system creates a virtuous develop, test, deploy, refine, test and redeploy platform. It is low cost, quick to change in the field and then can be reconfigured via aggregated masked ROM steps to open up RAM code space for further sets of future improvements.

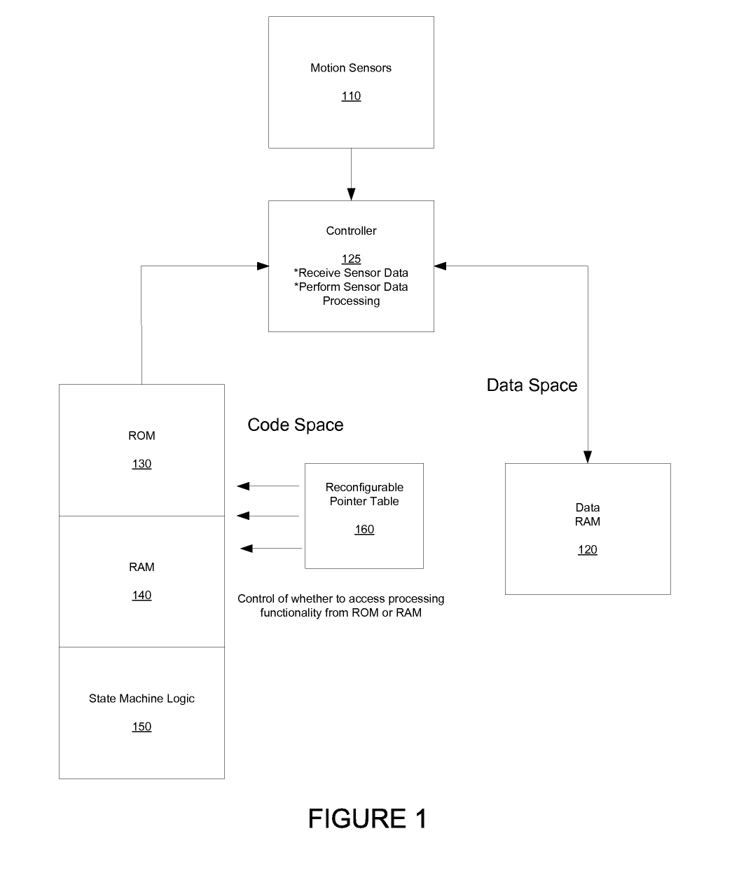

FIG. 1 shows a block diagram of a sensor processing memory architecture, according to an embodiment. This embodiment includes a plurality of sensors 110, data space RAM (random access memory) 120, code space ROM (read only memory) 130 and code space RAM 140, a reconfigurable pointer table 160 for maintaining a pointer address to the code space ROM and code space RAM of a sensor data processing function. This embodiment further includes a processor 125.

For at least some embodiment, the processor 125 is operative to receive sensor data from the plurality of sensors 110, store the sensor data in the data space RAM 120, retrieve code in the code space ROM 130 and the code space RAM 140, and perform processing of the sensor data, including retrieving one or more sensor data processing functions from at least one of the code space ROM 130 or code space RAM 140 as determined by the reconfigurable pointer table 160. At least some embodiments further include state machine logic 150.

As previously described, at least some embodiments include maintaining at least a portion of the code in subroutine or functional block form in the code space ROM 130 where the size of the memory can be up to three times more dense and power efficient than RAM memory, yet retain the flexibility of how the wrapper calls the various pieces of what resides in ROM to create powerful, field reprogrammable algorithms at a fraction of the cost and power consumption of alternative approaches.

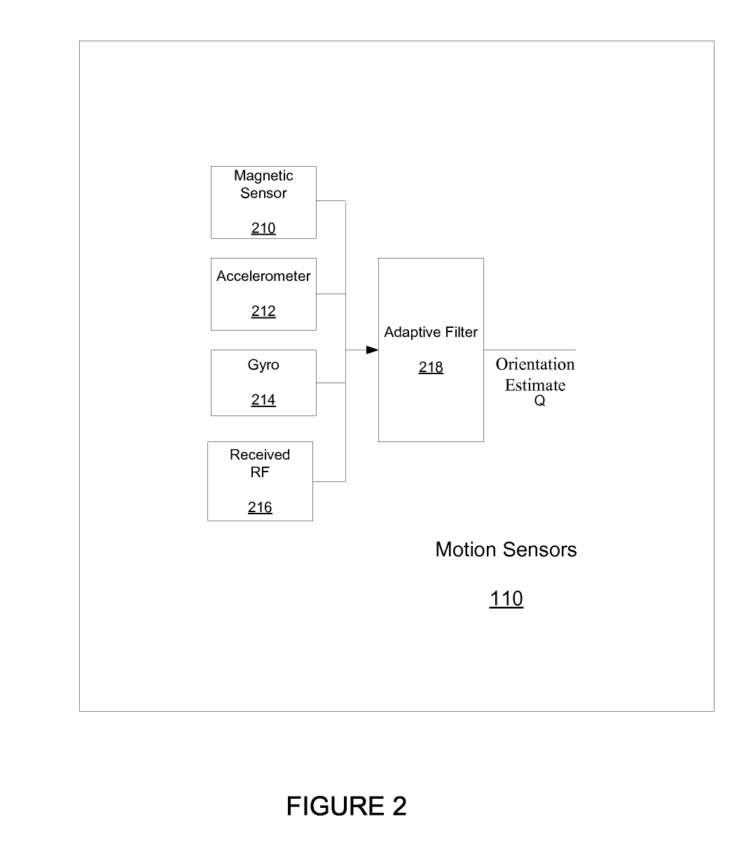

FIG. 2 shows motion sensors and an adaptive filter for providing sensor inputs to the sensor processing architecture, according to an embodiment. As shown, the motion sensors 110 include a magnetic sensor 210, an accelerometer 212, a gyroscope 214, and a received radio frequency (RF) input 216. The magnetic sensor 210 senses an ambient magnetic field of the device, accelerometer 212 senses acceleration of the device, and the gyroscope 214 senses an orientation of the gyroscope 214 which provides a representation of the orientation of the device. The RF input 216 represents RF signals received by the device that can be further used to determine motion and/or location information of the device.

Exemplary RF signals include, but are not limited to, cellular wireless signals, WiFi wireless signals, and/or Bluetooth signals. Each of these exemplary RF signals can be used to additionally characterize orientation/motion of the user and computing device of the user. For an embodiment, the adaptive filters are additionally or alternatively tuned based on characteristics of the RF signal being received.

It is to be understood that while an additional RF input is shown and described, other additional inputs can be included as well. Further, at least some embodiments include the use of a subset of the sensed signals shown in FIG. 2.

The sensed signals of the magnetic sensor 210, the accelerometer 212 and the gyroscope 214 are received by an adaptive filter 218. Based on the received sensed signals, the adaptive filter 218 generates an orientation estimate (Q_{E}) of the device 100. The orientation estimate (Q_{E}) includes a Quanternion. Quaternions, also known as versors, provide a convenient mathematical notation for representing orientations and rotations of objects in three dimensions.

For an embodiment, the adaptive filter 218 is implemented using a Kalman filter.

Kalman Filters

For an embodiment, the Kalman filter, includes a series of measurements observed over time, containing noise (random variations) and other inaccuracies, and produces estimates of unknown variables that tend to be more precise than those based on a single measurement alone. More formally, the Kalman filter operates recursively on streams of noisy input data to produce a statistically optimal estimate of the underlying system state. The Kalman filter has numerous applications in technology. A common application is for guidance, navigation and control of vehicles, particularly aircraft and spacecraft.

For an embodiment, the Kalman filter produces estimates of the current state variables, along with their uncertainties. Once the outcome of the next measurement (necessarily corrupted with some amount of error, including random noise) is observed, these estimates are updated using a weighted average, with more weight being given to estimates with higher certainty. Because of the Kalman filter's recursive nature, it can run in real time using only the present input measurements and the previously calculated state and its uncertainty matrix, while no additional past information is required.

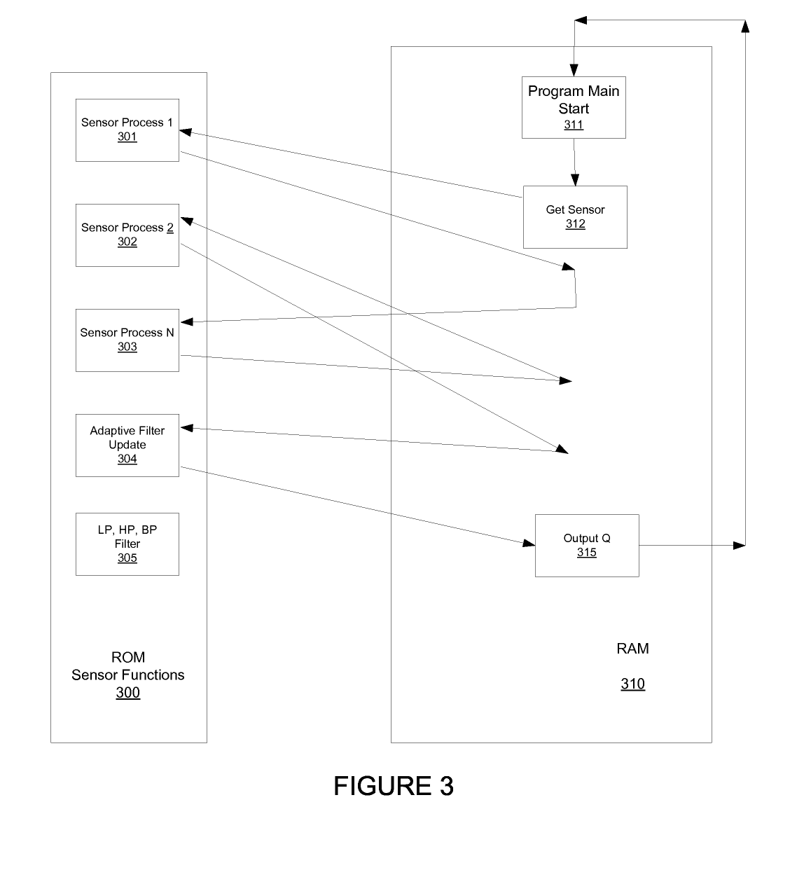

FIG. 3 shows a block diagram of ROM 300 wherein fixed subroutines, including Sensor Process 1, 2 through N (301, 302, 303), adaptive filter update 304, and Low Pass (LP), High Pass (HP) and Band Pass (BP) filters 305 are stored for use by the Main program stored in RAM 310. The Main program is reconfigurable and calls the Get Sensor subroutine, which is adaptable to different sensor driver requirements and calls in turn any combination of Sensor Processes 1 through N (301, 302, 303) as well as the Adaptive filter 304 and the various Low Pass (LP), High Pass (HP), and Band Pass (BP) filter combinations and outputs the resulting Q to any output port as desired. It is clear that because the program Main loop is stored in RAM 310, it can be easily modified, yet contain very little executable code (that is, less executable code that the ROM 300) when compared with the more complex subroutines stored in ROM 300. The configuration shown in FIG. 3 is meant to be representative but not limiting and it should be apparent that the specific subroutines called and their order of use can be any desired combination and that the subroutines in ROM are also purely representative and not meant to be limiting.

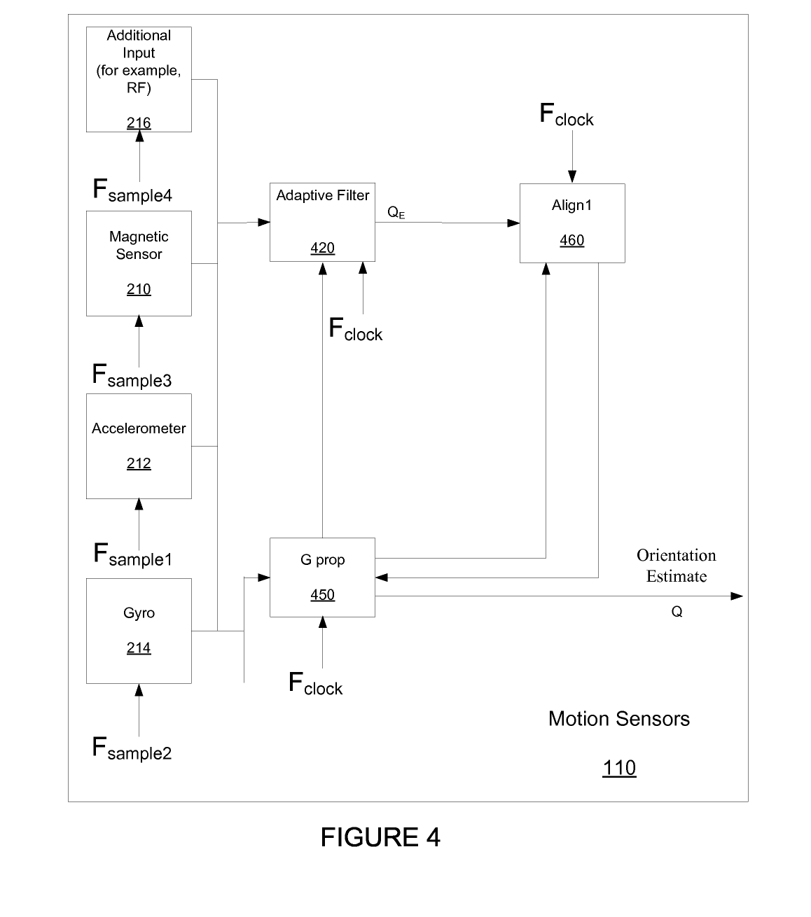

FIG. 4 shows motion sensors 210, 212, 214, 216 and an adaptive filter 420 for providing sensor inputs to the sensor processing architecture, according to another embodiment. This embodiment further includes gyroscope propagation device 450 and an alignment block Align 460. The alignment block 460 receives the output from the adaptive filter 420, and generates an alignment output for the gyroscope propagation device 340. The gyroscope propagation device 450 generates an output for the adaptive filters 420.

The gyroscope propagation device maintains the attitude and orientation as calculated solely based upon the gyroscope 214 outputs. For direct angular output gyroscopes this propagated value is determined by reading an angular encoder or the addition and subtraction of angular displacements calculated from an initial zero position. For angular rate sensor based gyroscopes, such as MEMS gyroscopes, the propagated angular displacement is calculated by an integration of the angular rate sensor output. In addition to the intrinsically higher noise characteristics possessed by MEMS gyroscopes, the integration step adds additional errors caused by the unknown constant of integration, as well as the Brownian random walk of the gyroscope offset (bias) due to the integration of broad band spectral noise. The adaptive filter update loop (in FIG. 4, the adaptive filter update loop includes, for example, adaptive filter 420, alignment block 460, and propagation device 450) takes as inputs the measured magnetic sensor (of the magnetic sensor 210), sensed acceleration (of the accelerometer 212), the gyroscope propagation value and the system's output quaternion value and calculates an error quaternion (such as, QE output of the adaptive filter 420) based upon the specific weighting of the state variable dependent coefficients within the adaptive filter 120. The error quaternion represents the filter's best estimate of the variance between the current gyroscope propagated value and the true angular rotations with respect to a known reference frame, such as the Earth's or device's reference frames. Once the error quaternions are calculated, the alignment block 460 simply multiplies the current gyro propagated value output by 450, the error quaternion QE, to produce the system's new output quaternions Q. The output quaternion Q is the value that best represents the true rotational position of the device in three dimensional space, and as previously stated, are also fed back into the adaptive filter update loops as one of the inputs for the calculation of the next error quaternion QE. For at least some embodiments, the structure of adaptive filter 420 is recursive and current outputs are based upon results calculated from the outputs of prior measurement steps.

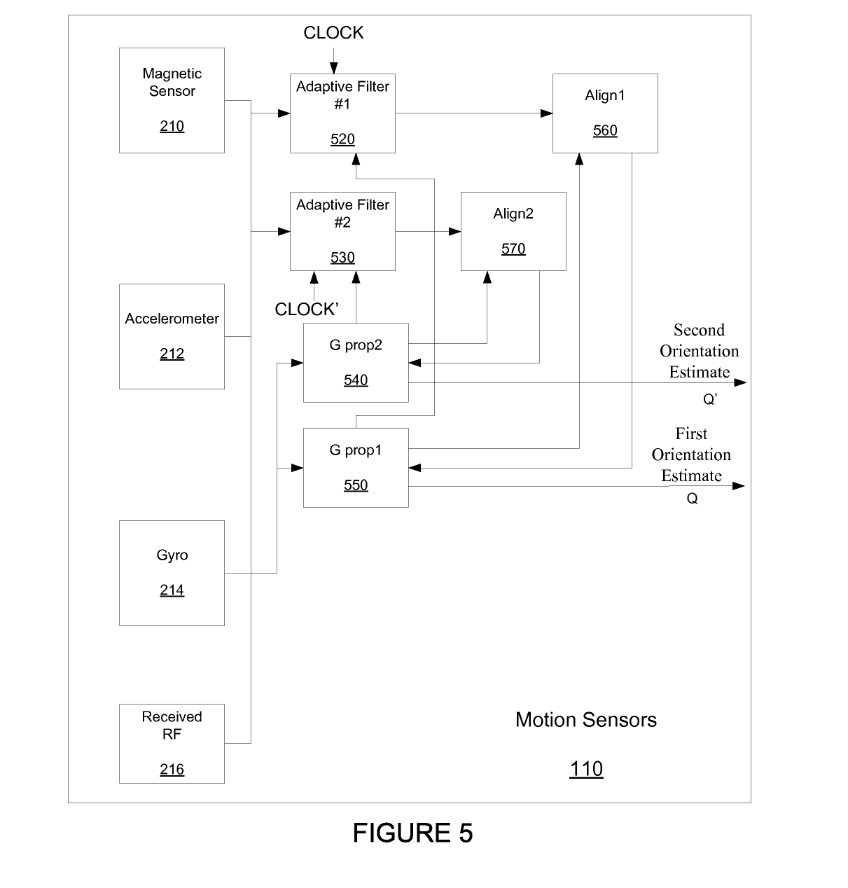

FIG. 5 shows motion sensors and an adaptive filter for providing sensor inputs to the sensor processing architecture, according to another embodiment. A first adaptive filter 520 generates a first orientation estimate (Q) based on the magnetic field of the magnetic sensor 210, sensed acceleration of the accelerometer 212, and the sensed orientation of the gyroscope 214. Further, some embodiments can further include an RF input 216. Further, a second adaptive filter 530 generates a second orientation estimate (Q′) based on the magnetic field of the magnetic sensor 210, sensed acceleration of the accelerometer 212, and the sensed orientation of the gyroscope 614. Further, some embodiments can further includes the RF input 216

As shown, the first adaptive filter 520 and the second adaptive filter 530 include clocks (CLOCK and CLOCK′) that clock the processing of the adaptive filters 520, 530. For an embodiment, the rate of the clock of the first adaptive filter 520 is the same as the rate of the clock of the second adaptive filter 530. For an embodiment, the rate of the clock of the first adaptive filter 520 is different from the rate of the clock of the second adaptive filter 530. The clock rates can be selected for each adaptive filter based upon the type of motion being sensed by each adaptive filter, which can be different for each adaptive filter.

This embodiment further includes gyroscope propagation devices 540, 550 and alignment blocks Align1 560, Align2 570. The alignment block 560 receives the output from the adaptive filter 520, and generates an alignment output for the gyroscope propagation device 550. The gyroscope propagation device 550 generates an output (first orientation estimate Q) for the adaptive filter 520. The alignment block 570 receives the output from the adaptive filter 530, and generates an alignment output for the gyroscope propagation device 540. The gyroscope propagation device 540 generates an output (second orientation estimate Q′) for the adaptive filter 530.

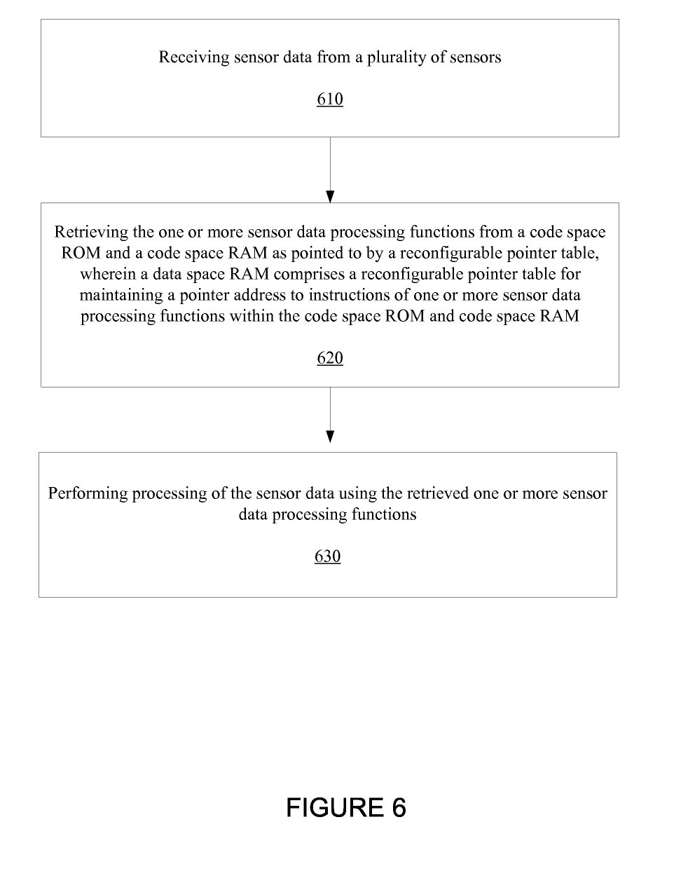

FIG. 6 is a flow chart that includes steps of a method of a sensor processing memory architecture, according to an embodiment. A first step 610 includes receiving sensor data from a plurality of sensors. A second step 620 includes retrieving the one or more sensor data processing functions from a code space ROM and a code space RAM as pointed to by a reconfigurable pointer table, wherein a data space RAM comprises a reconfigurable pointer table for maintaining a pointer address to instructions of one or more sensor data processing functions within the code space ROM and code space RAM. A third step 630 includes performing processing of the sensor data using the retrieved one or more sensor data processing functions.

For at least some embodiments, the code space is memory, whether volatile or not, wherein the executing instructions of a processing unit reside. For at least some embodiments, the data space contains values that are operated upon by the instructions stored in code space. Data space can also reside both in volatile as well as non-volatile memory.

For at least some embodiments, the reconfigurable pointer table is a block of memory that contains the memory addresses of either data or operations within a device's memory structure. For at least some embodiments, the reconfigurable point table is used by a Program Counter (PC) (of, for example, the processor 125) to jump to a particular area of memory to fetch either a piece of data to operate upon or an instruction to operate upon any given piece of data.

For at least some embodiments, the sensor data processing functions are retrieved based upon programmatic operators, which can include the value of the measured data, the sampling rate, or any combination of other logical or threshold based branching operations. For at least some embodiments, whether such data processing functions are retrieved from ROM or RAM program space is decided by the function that is being called and whether the pointer table points to that specific function (for instance a low pass filter) in the device ROM or RAM program space, which is typically determined and set up at the time of code compilation. For at least some embodiment, the selection of which memory space a given function is called from is done on a dynamic basis based upon code determined pointer values predicated on a threshold or other logical operation.

An exemplary embodiment includes a calculation of standard deviation performed upon measured sensor data. For this embodiment, the function may likely reside in ROM code space if such a function was known to be needed prior to the masked ROM being committed. However, if it was not known ahead of the committing of the masked ROM that a standard deviation calculation was necessary, such a function could be inserted into RAM code space along with its starting location in memory.

The described embodiments include a unique architecture with respect to the conventional combinations of MASKED-ROM and RAM. At least some of the described embodiments include program space RAM. At least some of the described embodiments provide for reconfiguration of programming code even after programed.

For at least some embodiments, the static sensor data processing functions are stored in the code space ROM, and dynamic sensor data processing functions are stored in the code space RAM. For at least some embodiments, the sensor data is received from motion sensors. For at least some embodiments, the motion sensors include one or more magnetic sensors, one or more gyroscopes, and one or more accelerometers.

For at least some embodiments, the static sensor data processing and the dynamic sensor data processing include motion sensor fusion processing. For at least some embodiments, the motion sensor fusion processing typically involves the measurement of any combination of rotational and translational motion undergone by a device using sensors that measure the same physical aspects of motion but using differing methods. An embodiment includes the measurement of a device's static and dynamic orientation about three rotational axes in a Cartesian coordinate system using a magnetic sensor, accelerometer, and a gyroscope. Each of these sensors is used to measure rotation, but the physics involved to do so by each is very different. The magnetic sensor measures rotation in reference to the Earth's magnetic field vector. The accelerometer measures rotation by measuring the rotations about the Earth's gravitational vector. The gyro measures pure rotational forces but in a relative manner only. It is because of the differences in the individual sensors' measurement principles that each has a very distinct error characteristic while making the measurements. But because they each are measuring the same device rotations, their measurements can be combined in way that allows their combined error space to be smaller than each individual sensor measuring in isolation. The method of properly combining the sensors' outputs to minimize their total measurement error is the basis of sensor fusion. One such technique is known as a Kalman (or adaptive) filter wherein each current measurement helps the system predict what the error contributions from the individual sensors are likely to be in the subsequent measurement, where the weighting of the contributions of the individual sensors are then adjusted to minimize the impact of the sensors with the highest errors and maximizes the impact of the sensors with the lowest errors. This approach is recursive in structure which further minimizes the amount of system resources necessary to make future weighting adjustments.

The described embodiments are useful for sensor fusion. For example, as described, it may desirable from a power saving's standpoint to have each of the sensors running at different sampling rates (for instance Gyroscope at 200 Hz, accelerometer at 100 Hz and magnetic sensor at 30 Hz) for higher dynamic motions in order to provide more instantaneously accurate measurements, but then slow the measurements down for slower movements of the device (for instance Gyroscope at 100 Hz, accelerometer at 50 Hz and magnetic sensor at 15 Hz). Aside from the need to change the sampling rate of the sensors, which can be conveniently done in data RAM memory, other aspects of the Kalman filter can be changed in order to maximize response rate of the Kalman at the lower sampling rates, such as the removal of a low pass filter from the sensor processing chain prior to inputting the data into the Kalman filter. This would help the system feel more responsive to quick movements and is acceptable since reducing the sampling rate intrinsically already provides a low pass filtering function. This is just one of many possible examples of how program RAM enabled flexibility is useful in sensor fusion.

For at least some embodiments, the dynamic data processing includes a structure of adaptive filtering of the sensed data of the motion sensors. For at least some embodiments, the structures of adaptive filters of the adaptive filtering is static and stored in ROM, and connectively of filter blocks of the adaptive filtering is adaptive and stored in RAM.

At least some of the described embodiment can beneficially be used for different motion measurement applications. For example, the described embodiments that include different weightings for different adaptive filters for filtering motion measurement information can be utilized to provide a quick response to fast sensed motion. This quick response to fast motion is useful for facilitating gesture control. Additionally, the different weightings for different adaptive filters for filtering motion measurement information can be utilized for response to slow sensed motion. The response to slow motion is useful for facilitating pedestrian dead reckoning wherein step direction needs to be measured in an accurate way on relatively slow occurring step boundaries. Further, the described embodiments include supporting two separate, but divergent uses cases simultaneously (gesturing while walking a route). In such cases, two separate filter paths can be run simultaneously on the same set of measured sensor inputs. The outputs of the two separate filter paths would be optimized specifically for each of the two differing applications. This is just one example of a use for this kind of architecture. There are many more.

For at least some embodiments, structures of adaptive filters of the adaptive filtering are static and stored in ROM, and clock rates of the adaptive filters is dynamic and stored in RAM.

As described, the structure of the adaptive filters may not change, and be stored in ROM. Further, for at least some embodiments, the multiple adaptive filter functional blocks are retrieved from the same portion of ROM. However, the configurations between the functional blocks can be adaptive and stored in RAM. Further, for at least some embodiments, how the adaptive filter blocks are connected can be adaptive and stored in RAM.

At least some embodiments include replacing a sensor data processing function from code space ROM with a modified sensor data processing function from code space RAM. The embodiments are useful for modifying or replacing processing functions of ROM.

For at least some embodiments, the code space RAM includes drivers for specific sensors. An example of the usefulness of having a sensor's driver running in program RAM includes the fact that each type of sensor may have several different manufacturers, such as the case with gyroscopes. Each of the gyroscopes will have different control registers for operation, or may even have different data bus requirements. In any case, a driver for one of the manufacturer's gyroscope can be loaded into program RAM, while another driver can be loaded to run a competitor's gyroscope as well, when necessitated by using that particular gyroscope in a system.

For at least some embodiments, the code space RAM includes operating code of the apparatus, and the code space ROM comprises subroutines. For at least some embodiments, the subroutines include standard simple or complex mathematical operations such as multiply, divide, addition, subtraction, square root, standard deviation, mean, tangent, cosine, sine, inverse, etc. These functions can be more complex such as low pass filter, high pass filter, band pass filter, fast fourier transform (FFT), and can be even more complex such as adaptive filtering, character recognition, sound recognition, etc. For at least some embodiments, any or all of these functions reside in ROM as their fundamental operation would never need to change, however these functions can be arbitrarily combined into more complex operations that are specific for a given application (such as gesture recognition). How the complex operation is structured in terms of the mathematical operations performed, what inputs they are performed on, etc, can be determined in the reconfigurable code space RAM.

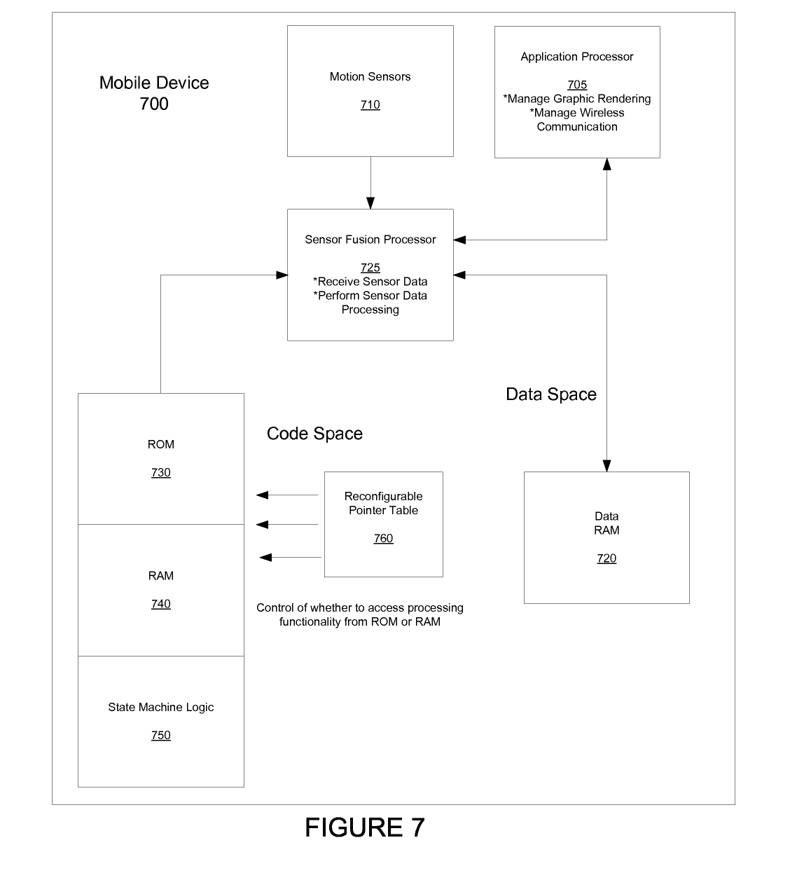

FIG. 7 shows a block diagram of a mobile device 700 that includes at least some embodiments of the sensor processing memory architecture, according to an embodiment. As shown, the mobile device 700 includes an application processor 705 operative to at least manage graphic rendering and communication of the mobile device 700. The mobile device further includes a plurality of sensors 710, code space ROM (read only memory) 710 and code space RAM 740, and data space RAM (random access memory) 720, wherein the data space RAM 720 includes a reconfigurable pointer table 760 for maintaining a pointer address to instructions of one or more sensor data processing functions within the code space ROM 730 and code space RAM 740. The mobile device 700 further includes a sensor fusion processor 725. The sensor fusion processor 725 is operative to receive sensor data from the plurality of sensors, retrieve the one or more sensor data processing functions from the code space ROM and code space RAM as pointed to by the reconfigurable pointer table, and perform processing of the sensor data using the retrieved one or more sensor data processing functions. The described embodiments for sensor processing are operable on the mobile device 700. At least some embodiments further include state machine logic 750.

Although specific embodiments have been described and illustrated, the described embodiments are not to be limited to the specific forms or arrangements of parts so described and illustrated. The embodiments are limited only by the appended claims.

What is claimed:

1. An apparatus, comprising:
a plurality of sensors;
code space ROM (read only memory) and code space RAM;
data space RAM (random access memory), wherein the data space RAM comprises a reconfigurable pointer table for maintaining a pointer address to instructions of one or more sensor data processing functions within the code space ROM and code space RAM;
a processor, the processor operative to:
receive sensor data from the plurality of sensors;
retrieve the one or more sensor data processing functions from the code space ROM and code space RAM as pointed to by the reconfigurable pointer table;
perform processing of the sensor data using the retrieved one or more sensor data processing functions.

2. The apparatus of claim 1, comprising storing static sensor data processing functions in the code space ROM, and storing dynamic sensor data processing functions in the code space RAM.

3. The apparatus of claim 1, wherein the sensing includes motion sensing, and the sensors include motion sensors.

4. The apparatus of claim 3, wherein motion sensors comprise one or more magnetic sensors, one or more gyroscopes, and one or more accelerometers.

5. The apparatus of claim 4, wherein the static sensor data processing and the dynamic sensor data processing include motion sensor fusion processing.

6. The apparatus of claim 5, wherein the dynamic data processing includes a structure of adaptive filtering of the sensed data of the motion sensors.

7. The apparatus of claim 6, wherein structures of adaptive filters of the adaptive filtering is static and stored in ROM, and connectively of filter blocks of the adaptive filtering is adaptive and stored in RAM.

8. The apparatus of claim 6, wherein structures of adaptive filters of the adaptive filtering is static and stored in ROM, and clock rates of the adaptive filters is dynamic and stored in RAM.

9. The apparatus of claim 1, wherein the processor is further operative to replace a sensor data processing function from code space ROM with a modified sensor data processing function from code space RAM.

10. The apparatus of claim 1, wherein the code space RAM includes driver for specific sensors.

11. The apparatus of claim 1, wherein the code space RAM comprises operating code of the apparatus, and the code space ROM comprises subroutines.

12. A method, comprising:
receiving sensor data from a plurality of sensors;
retrieving one or more sensor data processing functions from a code space ROM and a code space RAM as pointed to by a reconfigurable pointer table, wherein a data space RAM comprises a reconfigurable pointer table for maintaining a pointer address to instructions of one or more sensor data processing functions within the code space ROM and code space RAM; and
performing processing of the sensor data using the retrieved one or more sensor data processing functions.

13. The method of claim 12, wherein static sensor data processing functions are stored in the code space ROM, and dynamic sensor data processing functions are stored in the code space RAM.

14. The method of claim 12, wherein the sensor data is received from motion sensors.

15. The method of claim 14, wherein motion sensors comprise one or more magnetic sensors, one or more gyroscopes, and one or more accelerometers.

16. The method of claim 15, wherein the static sensor data processing and the dynamic sensor data processing include motion sensor fusion processing.

17. The method of claim 16, wherein the dynamic data processing includes a structure of adaptive filtering of the sensed data of the motion sensors.

18. The method of claim 17, wherein structures of adaptive filters of the adaptive filtering is static and stored in ROM, and connectively of filter blocks of the adaptive filtering is adaptive and stored in RAM.

19. The method of claim 18, wherein structures of adaptive filters of the adaptive filtering is static and stored in ROM, and clock rates of the adaptive filters is dynamic and stored in RAM.

20. The method of claim 12, further comprising replacing a sensor data processing function from code space ROM with a modified sensor data processing function from code space RAM.

21. A mobile device, comprising:
an application processor operative to manage graphic rendering and communication of the mobile device;
a plurality of sensors;
code space ROM (read only memory) and code space RAM;
data space RAM (random access memory), wherein the data space RAM comprises a reconfigurable pointer table for maintaining a pointer address to instructions of one or more sensor data processing functions within the code space ROM and code space RAM;
a sensor fusion processor, the sensor fusion processor operative to:
receive sensor data from the plurality of sensors;
retrieve the one or more sensor data processing functions from the code space ROM and code space RAM as pointed to by the reconfigurable pointer table;
perform processing of the sensor data using the retrieved one or more sensor data processing functions.
